(19) United States
(12) Patent Application Publication
(10) Pub. No.: US 2026/0063891 A1
(43) Pub. Date: Mar. 5, 2026

(54) FLAT, WIDE APERTURE BINOCULAR EYEGLASSES

(71) Applicant: Soliddd Corp., New York, NY (US)

(72) Inventor: Neal Weinstock, New York, NY (US)

(21) Appl. No.: 19/311,548

(22) Filed: Aug. 27, 2025

Related U.S. Application Data
(60) Provisional application No. 63/688,280, filed on Aug. 28, 2024.

(51) Int. Cl. G02B 25/00; G02C 7/08

(52) U.S. Cl. CPC G02B 25/004; G02C 7/088

(57) ABSTRACT

One embodiment provides a system and method that combine at least one flat, wide aperture telephoto lens with an objective lens, in the same overall lens structure with any common corrective or tinted eyeglass lens in a frame offering simple adjustability for intraocular distance. The invention thus allows for binoculars with strong telephoto magnification and fine focal detail with no need to adjust proper focus for any viewer’s visual acuity, and simple gaze shift to and from telephoto view and any different typical eyeglass lens, all in a common eyeglass form that is lightweight enough and thin enough for constant comfortable wear. Other embodiments are described herein.

### CROSS-REFERENCE TO RELATED APPLICATIONS

This application is a non-provisional conversion of U.S. Provisional Application Serial No. 63/688,280, filed August 28, 2024, the contents of which are incorporated by reference herein.

### FIELD OF THE INVENTION

The present disclosure generally relates to a visual aid device, more particularly, to a form of eyeglasses that can provide both telephoto magnification and more typical corrective lenses or sunglasses in the same device that is lightweight and thin enough for constant wear comparable to any normal eyeglasses.

### BACKGROUND OF THE INVENTION

Binoculars, or opera glasses, may often be minimized in size such that they can fit into or over common eyeglass frames, but nevertheless they still are sufficiently large and unwieldy such that most users would not want to wear them for more than a few minutes at a time. Existing binocular designs suffer from several deficiencies: For one, in typical optical designs, binoculars are too heavy to rest comfortably like normal eyeglasses and must be supported by the user’s hands or on some kind of mechanical support. For another, the smaller the opera glasses (thus aiding portability and comfort), the smaller the aperture and thus the less detail and field of view that can be seen at distance. Additionally, other visual aid devices that include magnification or de-magnification capabilities are not always ideal for use together with binoculars. Wearers of corrective eyeglasses either must push the binoculars’ objectives against their glasses or take off their corrective glasses and adjust the binoculars’ objective focus for their required correction. Either way, moving one’s attention from the telephoto view to close reading or to normal distance view is cumbersome. All typical lightweight eyeglasses suffer from being unable to provide much magnification compared with multiple-element opera glasses or binoculars, and the opera-glass or binocular alternative is too heavy and unwieldy to utilize for extended periods of time, and cannot easily allow the user to quickly shift their eye position into and out of a magnification zone such as one can do with bi- or tri- or multi-focals.

### SUMMARY OF THE INVENTION

Many kinds of visual aid devices are helpful for correcting or enhancing a user’s vision, including demagnification lenses for nearsightedness, magnification lenses for farsightedness, binoculars and opera glasses that assist a user in seeing something from a distance. However, none of these devices provide a lightweight, thin and small package while still allowing for a viewing field typical of eyeglasses, allowing for viewing zones such as bifocals provide but with one of those zones being a telephoto, and providing sufficient detail when viewing objects from a distance. The described system integrates lens elements that provide high-power binoculars with a wide aperture into the same thin and lightweight form that can also include common eyeglasses (whether for near or far-sightedness, single prescription per eye or bi- or multi-focals, or sunglasses, anti-glare glasses, etc.) Thus, the described system provides a combination of unique binoculars or opera glasses with any kind of existing eyeglasses, and allows for users to easily adjust their vision to use either the binoculars or the other areas of the glasses in the same manner in which users change views between different areas of bifocals.

One embodiment provides a frame having what appears to the user as two typical eyepieces; however, each of those eyepieces consists of at least two separate apertures with one ringing around the other(s); and somewhere in the middle area of the overall eyepiece, a distinct objective lens works like a bifocal to present the view captured by the aperture created by the outer ring.

### A BRIEF DESCRIPTION OF THE DRAWINGS

FIG. 1 illustrates a plano view of the typical folded optical design of the flat, wide aperture telephoto lens with an objective lens. Dotted lines show ray tracings of the path of light captured by the parabolic ring aperture. These are reflected by the large parabolic ring towards a central hyperboloid, which reflects the light down to a focal plane at which the light is captured by an objective lens and presented to the eye.

FIG. 2 illustrates an exploded plano view of the typical folded optical design of the telephoto lens with an objective lens. At top is the hyperboloid reflector; in center is the parabolic ring reflector. At bottom is the an objective lens.

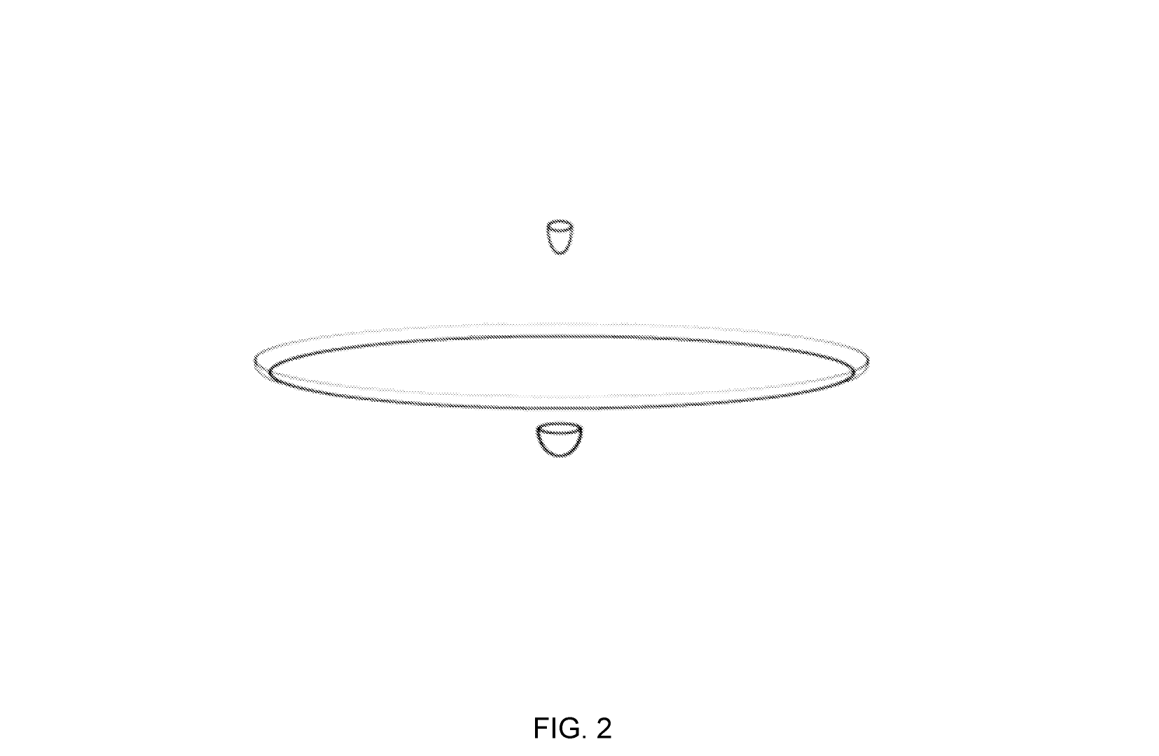

FIG. 3 illustrates a view from the outside of the telephoto ring lens structure. The parabolic ring reflector surrounds an area which can be made into a separate lens with a differing prescription, or tinted for sunglasses. In the center, the circle designates both the hyperboloid reflector and, beneath it and unseen, the canister-or cylinder-like barrier and the objective lens.

FIG. 4 illustrates an example visual device including the telephoto lens with parabolic ring reflector, hyperbolic reflector and objective surrounded by a barrier, with other lens area which can be used for any common corrective or tinted optics circumscribed by the parabolic ring and surrounding the hyperbolic reflector and objective.

FIG. 5 illustrates a side view of the example visual device of FIG. 4.

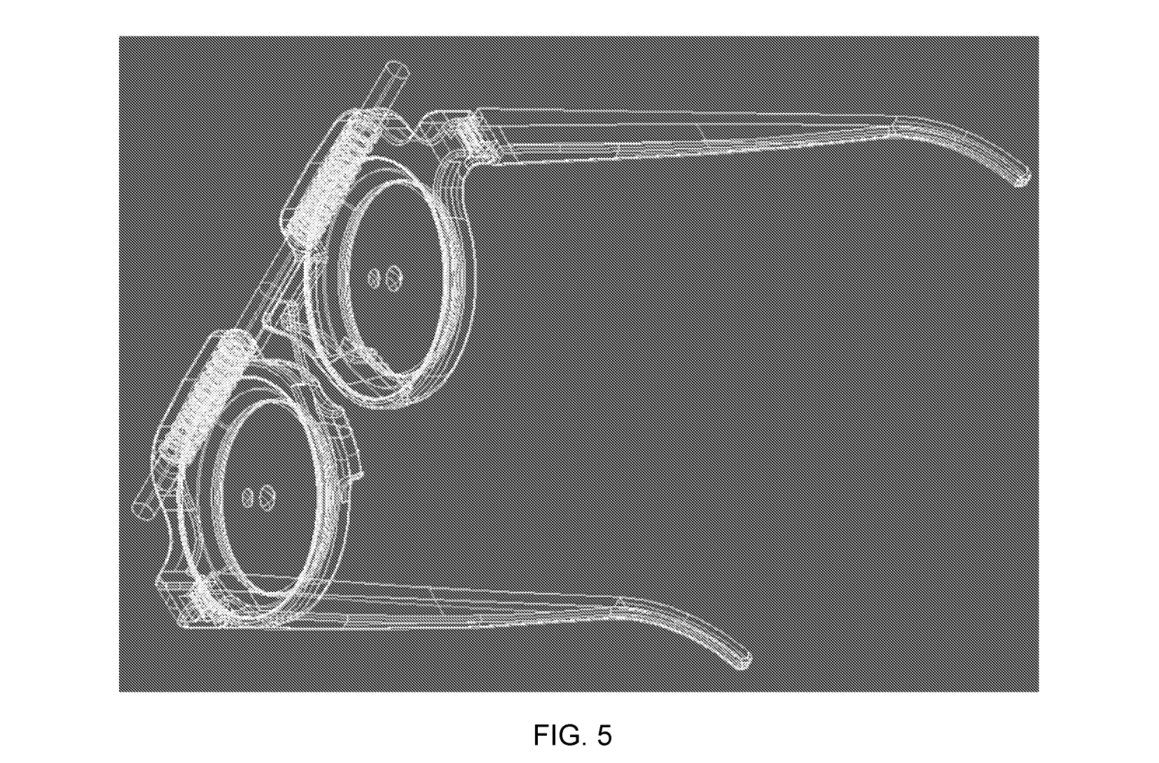

FIG. 6 illustrates a front view of the example visual device of FIG. 4.

### DETAILED DESCRIPTION OF THE INVENTION

The described system and method provide a technique to utilize multiple lens elements and simple adjustment methods in combination within a typical lightweight and thin eyeglass frame, thereby providing a device that allows a user to easily shift eye position between a wide aperture telephoto binocular view and either common sunglasses or some other common corrective lenses. Such a device is essentially passive, requiring no electric power and no focal adjustment, but it can be integrated with other devices including for such purposes as digital photography, recording, focal adjustment, zoom adjustment, and/or the like.

The described visual aid device can utilize the optical aperture and imaging optics like those described in commonly owned U.S. Patent Application Serial Number 17/976,444, filed October 28, 2022, and titled “FLAT APERTURE TELEPHOTO LENS,” the contents of which are incorporated by reference herein.

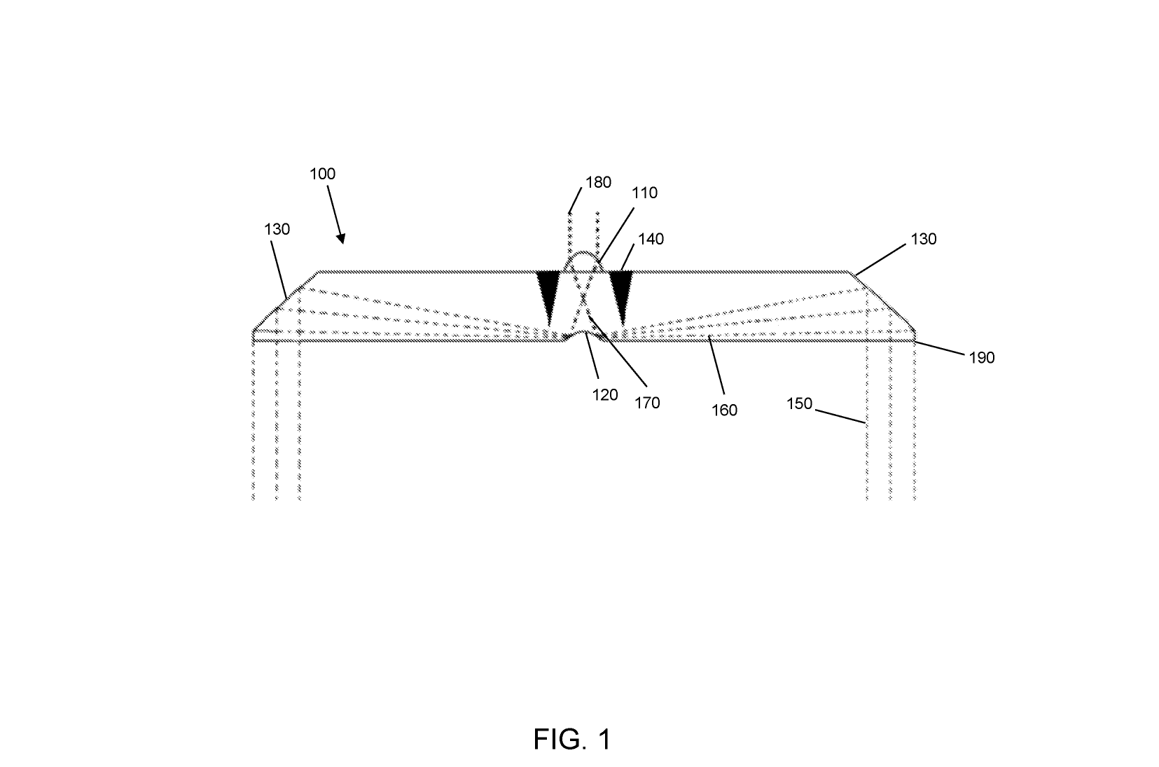

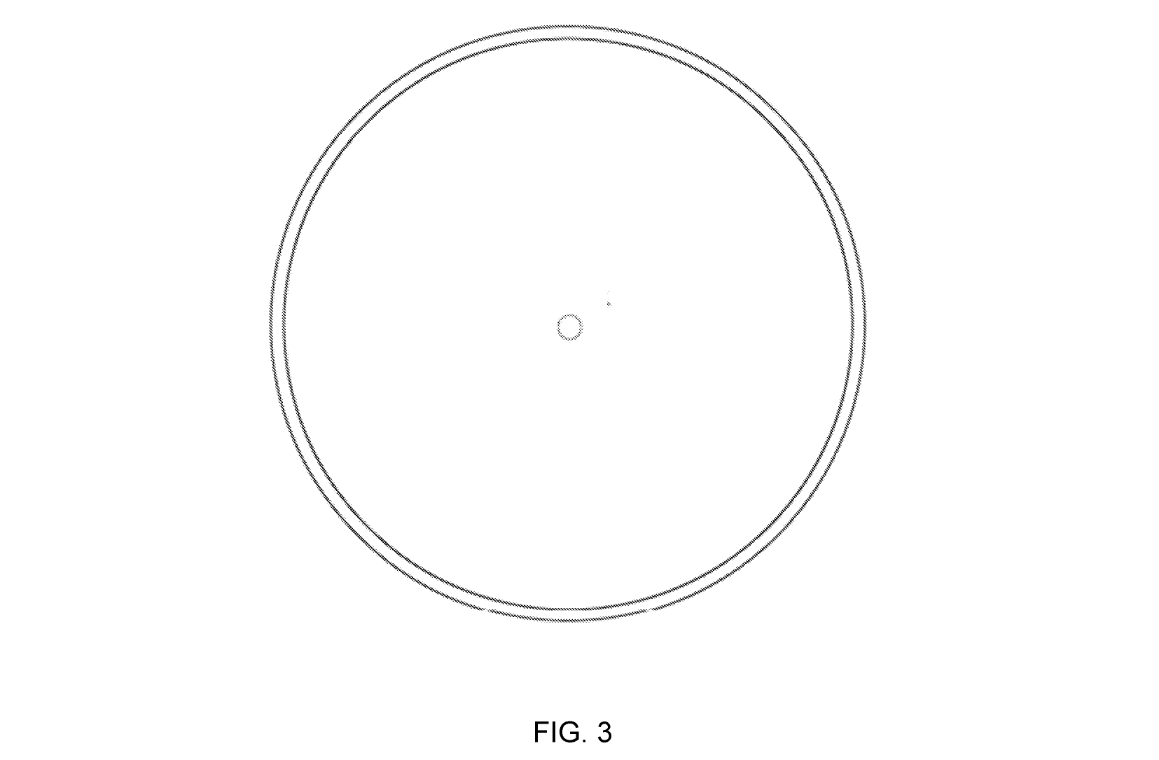

FIG. 1 – FIG. 3 illustrate an example of the flat telephoto optic design 100 as described in connection with the above-mentioned Patent Application, as combined here with an objective lens 110. Any appropriate objective lens design may be used, in order to serve as an eyepiece for the telephoto view. As is commonly understood by those versed in the art of lens design, the eyepiece has a small focal length F2, and its role is to let eye focus on the image of the primary lens which has focal length F1. The focal length of the primary lens may be any given choice based on the expected typical application of the telephoto glasses, as will also be well understood by those versed in the art. If operated in this manner, magnification will be F1/F2.

In the example illustration of FIG. 1, the objective lens 110 is surrounded by a barrier 140, which extends from the back surface plane of the objective and out to such a point as to block ambient light or stray reflections from entering the objective lens, but not so far as to block the reflected light entering the hyperboloid from the paraboloid ring. This single, cylinder-like barrier is represented here by two wedge-shaped structures on either side of the objective lens. In other words, the two wedge-shaped structures are actually part of a single structure that encircles the objective lens, with an opening in the middle of the structure to allow light to be reflected from the first reflector device 120 to the objective lens 110. In a typical implementation, the barrier would be cut out of the transparent material holding the two-reflector-and-objective-lens structure together, with the cut then coated with any durable material that does not allow light to pass through. While the barrier is useful in blocking ambient light or stray reflections, it should be noted that the barriers are not strictly necessary, and the device could be implemented without barriers. Additionally, the barriers may be of different shapes, sizes, and locations than that illustrated in FIG. 1.

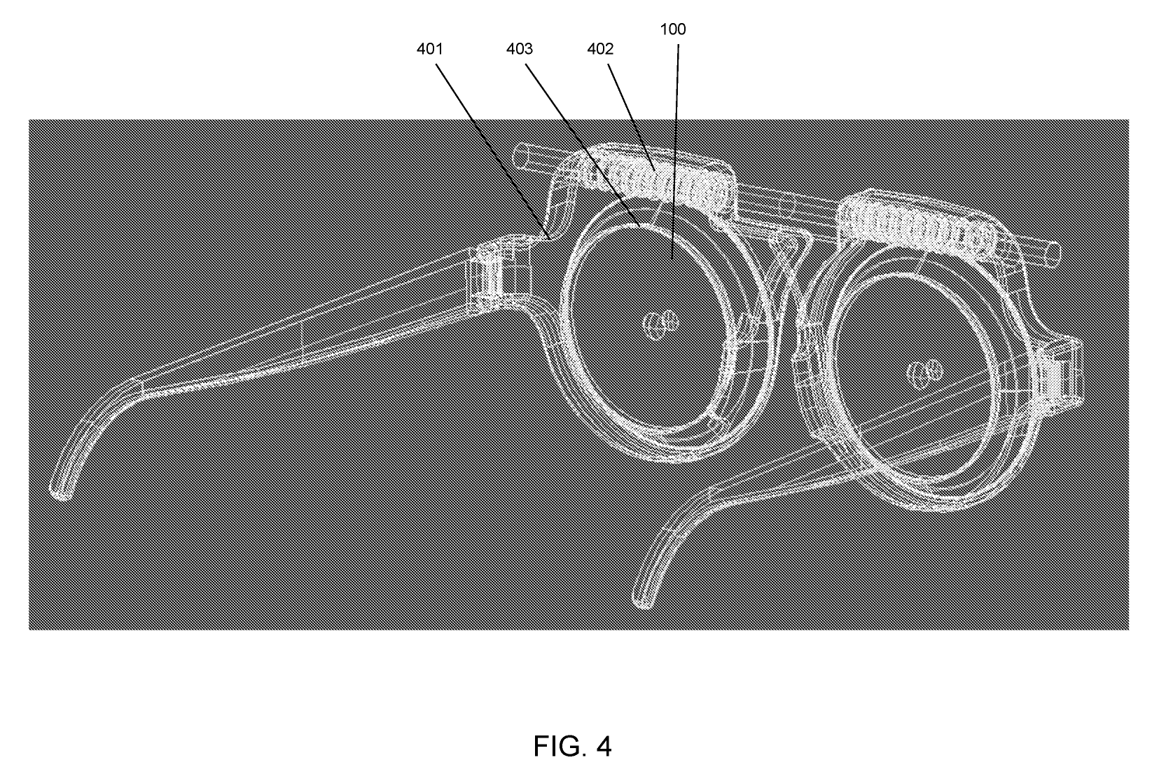

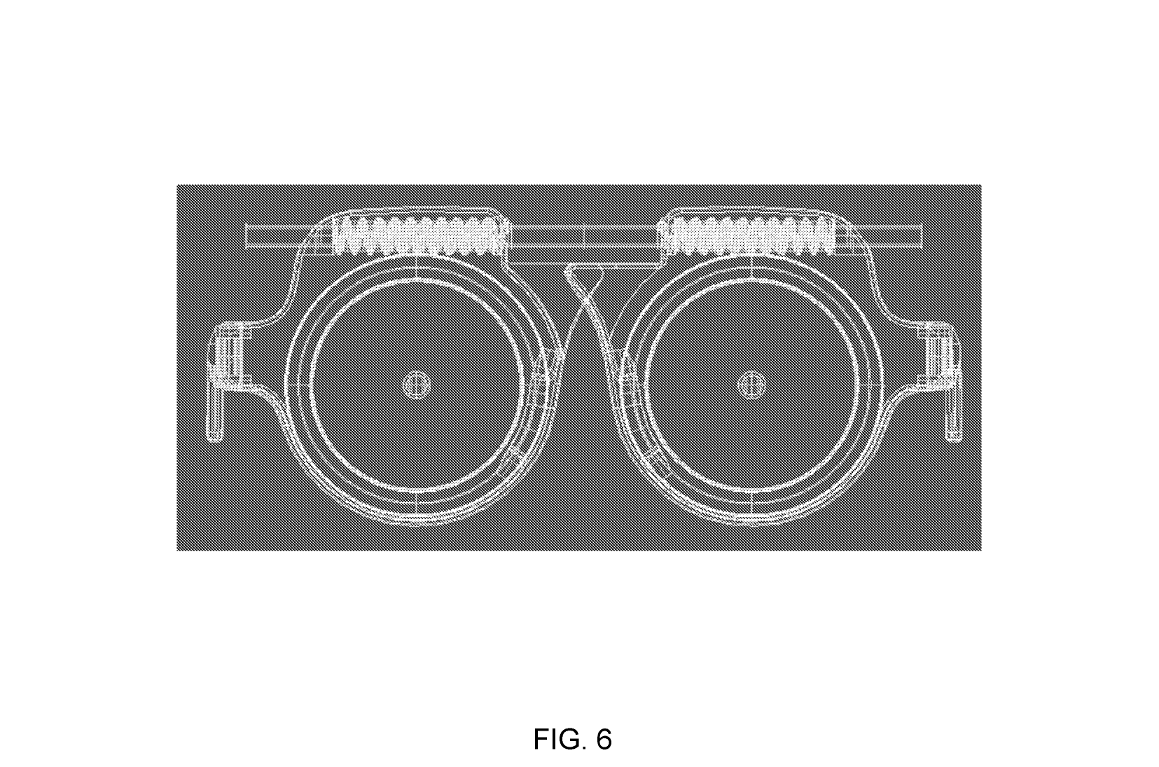

The visual aid device may include a frame 401, as illustrated in FIG. 4 – FIG. 6. In the case of eyeglasses, opera glasses, binoculars, and/or the like, the frame may include two or more openings. In the case of a magnifying glass, monocle, telephoto lens, telescope, or other such device, the frame may include a single opening.

Images of the described device in connection with opera glasses are illustrated in FIG. 4 – FIG. 6. The device may utilize one or more optical apertures that are located with respect to each of the openings of the frame. Since the optical apertures may be sparsely-filled optical apertures as described in connection with the above-mentioned Patent Application, they may be located in one or more zones within the area circumscribed by the parabolic ring reflector of the flat, wide aperture telephoto, or also may be located at other places on the frame around the opening and have no components that interfere with the lens area or opening of the frames. In other words, the optical apertures may be located around a rim of the openings of the frame, or anywhere within that rim. Thus, the optical aperture may be built into the rims of the frame of the device. The shape of the optical aperture can vary depending on the frame that is utilized. In the case of a frame having a single opening or more than two openings, the number of optical apertures is at least equal to the number of openings in the frame.

As taught in the above referenced Patent Application, the parabolic ring portion of the flat, wide aperture telephoto may also be sparsely filled; in other words, the “ring” may be composed of multiple sections separated physically from each other. Making use of this set of variations in optical design, the overall shape of the “ring,” and thus of the eyeglass frame holding the overall lens structure, may be made in any shape that the eyeglass stylist desires.

As also taught in the referenced Patent Application, the flat, wide aperture telephoto may include zoom optics. These may be located in multiple possible places within the multiple lens structure or the frame of this device.

The device also includes other imaging optics. Like the optical apertures, the number of sets of imaging optics is at least equal to the number of openings in the frame but may also exceed that number by including common bi- or multifocal lenses or multiple flat, wide aperture telephoto lenses. The device may have a different number of optical apertures as compared to the number of imaging optics and/or openings in the frame.

The location of the imaging optics with respect to the frame may be around the rim of the opening. In other words, the location of the imaging optics may be similar to the location of the optical aperture with respect to the opening of the frame. However, it should be noted that the imaging optics and optical aperture do not have to be at the exact same location around the rim of the opening. Rather, the imaging optics and optical aperture could be located at different positions around the rim of the opening.

The imaging optics may include at least one reflection device 120 that is optically located after the optical aperture 190. The reflection device may be a hyperboloid reflector, as illustrated at 120. The device may include multiple reflection devices, for example, as illustrated in FIG. 1 at 130 and 120. Multiple reflection devices within the line of the light may allow for a thinner device. The position of the at least one reflection device with respect to the optical aperture may vary based upon the shape of the optical aperture. The reflection device may be located to be at the center of the light gathered by the optical aperture 160, as described in the previously mentioned Patent Application. The reflector 120 then reflects the gathered light 160 onto a lens 110 located within the opening 403 of the frame. While light is discussed herein, it should be noted that this light 150 corresponds to a scene that is being viewed by a user. Thus, rather than simply light, the system is actually capturing and reflecting light and information related to a scene that the user is viewing.

The focal point of the gathered light reflected by the reflection device 130/120 (at least one for each opening in the frame), is the entrance pupil of a lens which is located within the opening(s) of the frame. The image 170 presented to or reflected onto the lens 110 is an inverse image. The lens receives the inverse image and inverts it 180, making it visible in proper perspective to a viewer in full focus at infinity. Since the device may have multiple openings, it should be noted that the magnification value can be different across the openings. In other words, and using the example of two openings, one opening may magnify the scene or portion of a scene by one magnification value and the other opening may magnify the scene or portion of a scene by a different magnification value. This may be particularly useful when utilizing the described device as a visual field correction device where the user may have differing needs for each eye. Thus, the described device can be modified or adjusted to be unique to a particular user.

For the viewer, the system enables the opportunity to look with both eyes into the pair of lenses and see a magnified telephoto image. Using optical design methods, the image could fit the definition of 7 x 35 or 10 x 40 or whatever binocular magnification and field of view specification is desired. When the viewer looks to any side of the objective lenses, the glasses can feature a correction for nearsightedness or farsightedness, or sunglasses, or any other typical eyeglass application. Aiding in the user’s ability to center both eyes’ vision on the two lenses, the described device features any method to adjust intraocular distance: that is, the glasses may feature an adjustable hinge at the bridge of the nose that connects the two eyepieces, or an adjustable screw that brings the eyepieces closer to each other or farther apart, or the like. The adjustment may be used not only to bring the two lenses to a comfortable distance for optimized stereo viewing, but also to space them out of the way easily for those times when the user wants to look through other sections of the eyeglasses for corrective purposes, or protection against bright sunlight, or the like.

The wide-aperture ring structure, reflection device, barrier, and the objective lens are rigidly held in precise juxtaposition by a molded or cut and ground plastic or glass structure which may be used for a different lens 100 or eye protection as described above. The elements of the parabolic ring structure of the optical aperture and the reflectors and the barrier may be powder coated onto this centerpiece lens, in a preferred implementation, or may be cast or molded or printed in any other typical manner. The objective lens may be molded or cast as an integral part of this overall structure, or manufactured as a separate piece as is commonly done for such lenses and fitted and bonded onto the appropriate place in the structure.

Thus, the described system provides a combination of an objective with a flat, wide aperture telephoto. It also provides a three-element lens (e.g., paraboloid, hyperboloid, and objective) in a structure that also can hold a more common corrective lens or sunglass, and that includes a barrier to keep ambient light away from the telephoto view seen through the objective lens. Additionally, the system provides the three-element lens in an eyeglass frame that allows for intraocular adjustment. The system provides binoculars that offer strong telephoto capabilities but are still thin and lightweight enough to rest comfortably on a user’s ears and nose like common eyeglasses, for example, in an opera glasses form. The thickness of the system may be 10mm or less.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A visual aid device, the visual aid device comprising:
a frame comprising at least one opening;
at least one optical aperture, wherein each of the at least one optical apertures are located with respect to and being associated with one of the at least one openings; and
at least one set of imaging optics comprising at least one reflection device, wherein the at least one reflection device reflects light into the at least one opening.

2. The visual aid device of claim 1, wherein the frame comprises two openings;
wherein the at least one optical aperture comprises at least two optical apertures; and
wherein each of the two openings comprises an associated at least one of the at least two optical apertures.

3. The visual aid device of claim 1, wherein the at least one optical aperture comprises a sparsely-filled optical aperture.

4. The visual aid device of claim 1, further comprising at least one parabolic ring reflector; and
wherein each of the at least one optical apertures is located within a zone of an area circumscribed by the parabolic ring reflector.

5. The visual aid device of claim 1, wherein the at least one optical aperture is located such as to not obstruct the at least one opening.

6. The visual aid device of claim 5, wherein the at least one optical aperture is built into rims of the frame.

7. The visual aid device of claim 1, further comprising at least one lens located within the at least one opening, and wherein the at least one reflection device reflects the light onto the lens.

8. The visual aid device of claim 7, wherein at least one lens comprises a flat aperture telephoto lens.

9. The visual aid device of claim 8, wherein the flat aperture telephoto lens comprises zoom optics.

10. The visual aid device of claim 8, wherein the at least one lens comprises an objective lens combined with the flat aperture telephoto lens.

11. The visual aid device of claim 10, further comprising a second reflection device and a barrier;
wherein the barrier is located so as to block ambient light from a path of the light from the second reflection device to the objective lens and to allow the light from the first reflection device to the second reflection device.

12. The visual aid device of claim 7, further comprising an adjustment device, wherein the adjustment device adjusts a location of the at least one lens.
